(19) United States
(12) Patent Application Publication
(10) Pub. No.: US 2011/0023393 A1
(43) Pub. Date: Feb. 3, 2011

(54) CORNICE

(76) Inventor: Steven Hartman, Brampton (CA)

Correspondence Address: MILLER THOMPSON, LLP, Scotia Plaza, 40 King Street West, Suite 5800, TORONTO, ON, M5H 3S1, CA

(21) Appl. No.: 12/533,174

(22) Filed: Jul. 31, 2009

(51) Int. Cl. E04F 19/04; B29C 47/78; B32B 5/14

(52) U.S. Cl. 52/287.1; 264/299; 428/310.5

(57) ABSTRACT

The present invention discloses a thermoplastic cornice member having a plurality of strands and a plurality of cells. The thermoplastic cornice member is extruded by an extruder that forms the shape of the thermoplastic cornice member. The thermoplastic cornice member is then cooled, providing the thermoplastic cornice member with a skin having a higher density than the interior of the thermoplastic cornice member. The strands and the skin give the thermoplastic cornice member a high strength and the skin also enables the thermoplastic cornice member to be painted or sprayed or brushed with adhesive. The adhesive enables the thermoplastic cornice member to be affixed to walls, ceilings, floors, or other panels.

### FIELD OF THE INVENTION

The present invention relates to thermoplastic trim detail. More particularly, the present invention relates to a process to fabricate a continuous extrusion thermoplastic product that can be used as cornice.

### BACKGROUND OF THE INVENTION

Traditionally the building material for cornice comprises of plaster or wood. The use of plaster or wood is time consuming and expensive. Moreover most homes will have baseboards made of wood at the lower part of a wall adjacent the floor. Also it is common to have chair rails, or other decorations on a wall, as well as wood trim around the door or window.

Cornice or crown molding can be used to aesthetically enhance the appearance of surface joints in a room such as a kitchen, living room, or bedroom. The cornice can be used between a wall and a ceiling or between two adjacent walls. Decorative trim could also be used as a doorframe or window frame. It can also be used around drapery boxes or other elements attached to walls and ceilings. Typically, cornice used between a wall and a ceiling is referred to as crown molding. Due to the various configurations that can exist for cornice, it would be beneficial to be able to provide a product at any length.

The prior art discloses various types of cornice that can be fabricated using thermoplastic foams. These foamed cornice products can be formed using a mold, extrusion, or sculpting. Typically, the foamed cornice products of the prior art are used to provide a structure for the cornice, while the fascia of the cornice is covered in a co-extrusion, a fabric, or some other covering material that is more aesthetically appealing that the foamed product. It would be beneficial to provide a product that does not always require a second material to provide a fascia.

Additionally, some of the prior art is affixed to a wall using nails or other fastening devices.

U.S. Pat. No. 5,601,912 to Ellingson discloses a thermoplastic co-extruded material comprised at least partially of recycled polystyrene. The material has a blown cellular core and a thin, high-impact, cap. In a preferred embodiment the material is used as crown molding and is comprised of a core having about 15% high-impact polystyrene and a cap of high-impact polystyrene. In the preferred embodiment the core comprises 20-85% recycled polystyrene. Ellingson, therefore, defines two densities of the foam to form the product.

U.S. Pat. No. 6,152,204 to Santoro discloses a cornice board having a base panel made of a relatively stiff foam material such as polystyrene. Padding and fabric cover the face side of the panel. The back side has a pair of brackets attached thereto and those brackets are affixed to a supporting surface, which in the case of a window cornice, would be a wall. Soft decorative objects such as dolls, landscaping, flowers, toys, etc. are easily attached in any location on the face side of the panel by means of special pins. Each bracket is of a simple two-piece construction that is separable and slidably justable to enable separate attachment of the bracket halves to the wall and panel back.

U.S. Pat. No. 6,877,545 to Parkerson discloses a foam cornice board for hanging curtains including a foam body having a decorative front surface defining a flat central and decorative upper and lower portions. The central portion is configured to receive a flat strip of decorative material such as a single vertical blind panel. The foam body further includes a notch formed into its back surface along the upper edge for receiving a mounting member connected thereto. For longer spans, a decorative foam keystone connector panel joins two adjacent cornice boards together which are abutted in end-to-end fashion. A decorative foam side cascade with a coextensive side panel is connectable to a wall, the side cascade having an upper margin configured for mating supportive engagement with a lower margin of the cornice board.

U.S. Pat. No. 6,918,977 to Maurer discloses an architectural molding including an extruded flexible plastic foam member having a front side, a rear side and a cross sectional profile. Also included is a layer of pressure sensitive adhesive affixed to at least a portion of the rear side and a release strip releasibly adhered to the layer of pressure sensitive adhesive. The foam is made flexible to enable optimal transport of the product, however the flexible nature of the product requires a solid backing to be applied when it is used as a crown molding.

U.S. patent application Ser. No. 10/385,343 to Badalamenti discloses a method of making and assembling foam crown molding including shaping a volume of foam into at least one strip having a desired shape of crown molding, finishing the at least one strip, and mounting the at least one strip onto at least one partition for decorating the at least one partition.

Furthermore, thermoplastic cornice foams disclosed in the prior art typically provide relatively large cells within the foamed material. The cells, when they collect moisture over time, increase the risk of rotting and bacteria growth.

In view of the foregoing, what is needed is a thermoplastic cornice that can be extruded to any length, does not require a second material to be used for providing a fascia, and has adequate rigidity so as to not require another material for a backing. What is further required is such a thermoplastic cornice that is made with a thermoplastic foam having relatively small cells.

### SUMMARY OF THE INVENTION

In one aspect of the present invention, a method of producing a thermoplastic member is provided, the method comprising: (a) continuously extruding a thermoplastic material through an extrusion die, the extrusion die having a plurality of orifices, the plurality of orifices oriented on the extrusion die so as to define approximately the shape of the thermoplastic cornice member; and (b) drawing the extrusion through a sizing and forming block to shape the thermoplastic cornice member into its final shape.

In another aspect of the present invention, a thermoplastic member is provided, the thermoplastic cornice member comprising: (a) a thermoplastic material defined by a plurality of strands and a plurality of cells; and (b) a surface layer of the thermoplastic material having a higher density than the interior of the thermoplastic material. The thermoplastic material in one embodiment can be a foamed polystyrene trim member or cornice.

### BRIEF DESCRIPTION OF THE DRAWINGS

FIG. 1 illustrates a cross sectional view of the preferred embodiment of a thermoplastic cornice member.

FIG. 2 illustrates a further cross sectional view of the preferred embodiment of the thermoplastic cornice member.

FIG. 3 illustrates the preferred embodiment of a thermoplastic extruder operable to produce a thermoplastic cornice member of variable length.

FIG. 4 illustrates the plate assembly for the extruder of the present invention corresponding to the preferred embodiment of the cornice member.

FIG. 5 illustrates two adjoining adjacent cornice members.

### DETAILED DESCRIPTION

In the description that follows, like parts are marked throughout the specification and the drawings with the same respective reference numerals. The drawings are not necessarily to scale and in some instances proportions may have been exaggerated in order to more clearly depict certain features of the invention.

The present invention discloses both a product and a process relating to foamed cornice.

In one aspect of the present invention, a method for producing polystyrene foam cornice is provided, the method comprising continuously extruding polystyrene foam through a die having a plurality of holes, the extrusion thereby having a plurality of strands, and the extrusion further being cooled through a second die. The cooling process causes the cornice to have a smooth exterior skin more dense than the interior of the cornice.

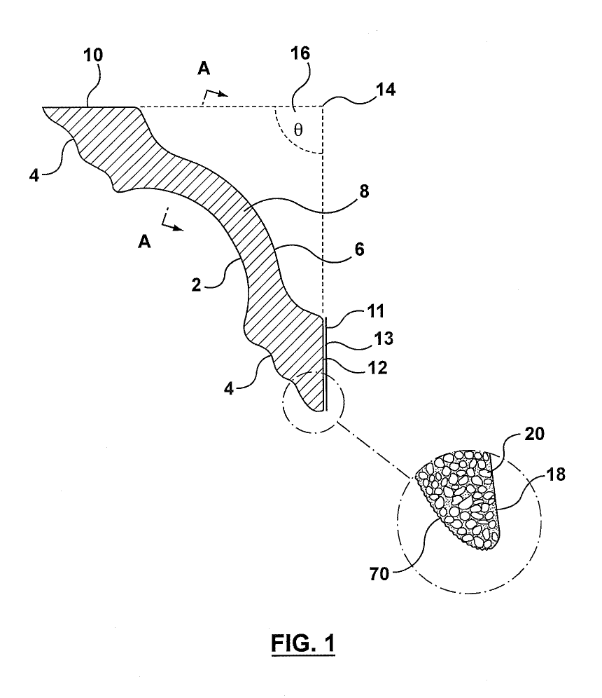

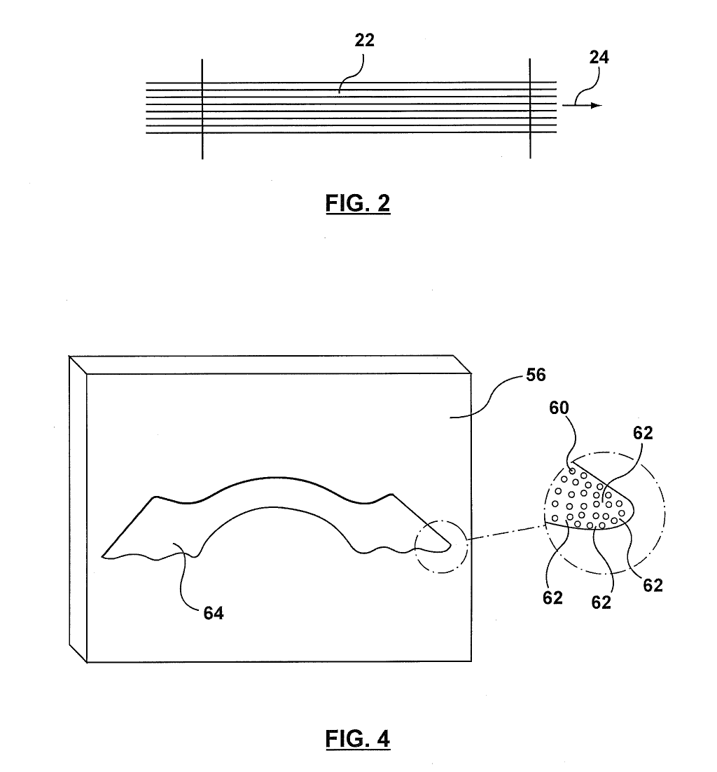

The present invention discloses a thermoplastic cornice that provides substantial advantages over the prior art. FIGS. 1 and 2 illustrate two aspects of the preferred embodiment of a thermoplastic cornice member.

FIG. 1 illustrates a cross sectional view of the preferred embodiment of a thermoplastic cornice member. The front surface of the cornice member may include one or more surface sections 2, 4 depending on the aesthetic design desired. The profile of the surface may be made to any specification so as to define any shape and length that would practically be used in association with a cornice member.

The rear surface 6 of the thermoplastic cornice member typically follows substantially the same curvature or shape as the corresponding front surface section 2 so as to enable optimal transport of a plurality of cornice members by stacking the cornice members' rear surfaces 6 to front surfaces 2. The rear surface 6 should also be at a great enough distance from the front surface 2 so as to produce a substantially thick structure 8 to prevent bending or breaking of the cornice member when exposed to such a force or torque typically experienced during transport and installation of cornice members.

The rear surface 6 of the thermoplastic cornice member may diverge from the curvature or shape of the corresponding front surface section 2 near the edge portions of the rear surface. This enables the edge portions of the rear surface 6 to define flat surfaces 10, 12 that give the cornice member substantial surface area contact with two planes joining at a joint 14, such as a wall and ceiling, wall and wall, or even wall and floor.

Notably, an extrapolation of the flat surfaces 10, 12 towards the joint 14 can define, in the preferred embodiment of the invention, a ninety degree angle 16 to further ensure that the cornice member will have substantial surface area contact with the joining planes. It should be understood that the flat surfaces 10, 12 could be designed so as to define any practical angle 16 to come into contact with a joint that is not necessarily ninety degrees, which may occur for example with the joint between a wall and a vaulted ceiling. Such a joint would typically have an angle 16 between ninety and one hundred eighty degrees, and more particularly could be approximately one hundred thirty five degrees.

The surface illustrated in the cross sectional view of the cornice member is made up of a hardened foam 18 defined by a plurality of cells 20. Formation of the hardened foam 18 and the cells 20 is a product of the extrusion and cooling process further described below.

FIG. 2 illustrates a further cross sectional view of the preferred embodiment of the thermoplastic cornice member along the plane A-A previously illustrated in FIG. 1. It can be seen that the cornice member is composed of a plurality of strands 22, which may or may not be as smooth as depicted in FIG. 2. The strands 22 are a product of the extrusion and cooling process further described below, wherein the cornice member is continuously extruded from an extruder in a direction 24 that is parallel to the orientation of the strands 22, the extrusion direction defining the orientation of the strands.

A member of thermoplastic cornice may preferably be formed using foamed plastic that is generally selected from the group of polystyrene, polypropylene, and polyethylene. In one embodiment a panel of thermoplastic cornice comprises a polystyrene with substantially smaller closed cell dimensions than the prior art.

The use of a small closed cell dimension substantially reduces the size and number of voids produced in a styrene foam sheet. Consequently, there is a greatly reduced chance of moisture collection, rotting, and bacteria growth using the product of the present invention than with the prior art.

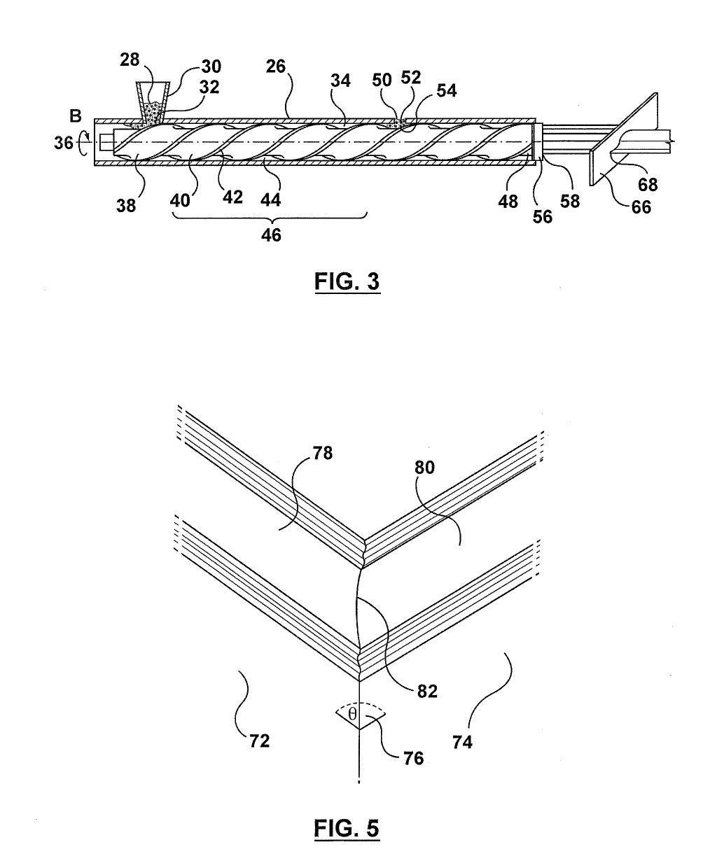

FIG. 3 generally illustrates one example of an extruder 26 for producing a thermoplastic material or product 4 which shall be more fully described herein.

Generally speaking the thermoplastic material starts off as thermoplastic solids 28 which may comprise pellets or the like that are introduced into a hopper 30 at an input end 32 of the extruder 26. The extruder 26 includes a barrel 34 which extends generally axially along the length of the extruder 26 about an axis 36. The extruder 26 includes a screw conveyer 38 co-axially disposed inside the barrel 34 along the axis 36. The screw conveyer 38 is adapted for relative rotatable movement about the axis 36.

In particular the screw conveyer 38 comprises a core 40 and an external flight or helical screw 42 for defining a passage 44 for conveying thermoplastic solid material 28 from the input end 32 to a thermoplastic melt zone 46 disposed between the input 32 and output 48 so as to melt the thermoplastic solid material 28.

The flights 42 of the screw conveyer 38 are arranged so as to convey the thermoplastic material to the passage 44 from the input 32 to the melt zone 46 to the output 48 as the screw conveyer 38 rotates in a direction B about the axis 36.

The flights 42 of the screw conveyer 38 also convey melted thermoplastic material under pressure from the thermoplastic melt zone to the output 48.

In operation as the screw conveyer 38 rotates along the axis 36 in a direction B thermoplastic solid material 28 is conveyed along the passage 44 from the input end 32 through to the melt zone 46 where the thermoplastic solid material 28 is melted as it is being conveyed to the output end 48. The melted thermoplastic material continues along the passage 44 to the output end 48.

The extruder 26 also includes means 50 for changing the characteristic of the thermoplastic solids 28. The means 50 comprises an aperture 52 which is disposed through the barrel 34 so as permit a user to add thermoplastic modifying material 54 into the melted thermoplastic material. Such means 50 would typically be at the point at which a blowing or foaming agent would be injected to produce the foamed cornice member.

Such means 50 for changing the characteristic of the thermoplastic material can comprise the addition of a substance selected from the group of thermoplastic pigment, dyes, thermoplastic resin, blowing or foaming agents, or other thermoplastic modifiers to the passage 44. For example the thermoplastic pigment may be added through the aperture 50 which is mixed with the melted thermoplastic material so as to change the colour of the melted thermoplastic material. Alternatively ultra violet stabilizers or other thermoplastic resin may be added thereto so as to change the characteristic of the melted thermoplastic material. Alternatively thermoplastic modifiers could be added to change the properties of the melted thermoplastic material.

For example the thermoplastic solid material 28 may comprise of any variety of thermoplastic material which is well known to those persons skilled in the art including polystyrene, polypropylene, and polyethylene. Once the thermoplastic material is melted in the melt zone 46 upstream of the aperture 52 in the passage 44 such melted material would be generally homogeneous. Blowing agents may be added to the extruder 26 in a manner well known to those persons skilled in the art so as to produce an expanded extruded profile that may be cut to length.

The output end 48 includes a plate assembly 56 which includes a plate opening 58 for communication with the passage 44. The plate assembly 56 may be operable to attach to the output end 48 by a fastening means such as, for example, a threaded attachment allowing the plate assembly 56 to screw onto the output end 48.

FIG. 4 illustrates the plate assembly for the extruder of the present invention corresponding to the preferred embodiment of the cornice member. The plate assembly 56 includes a plurality of holes 60 each spaced apart by a distance 62 approximately equivalent to the amount that the material extruded through a hole 60 will expand to come into contact with the material extruded through an adjacent hole 60. The plurality of holes 60 of the plate assembly 56 are arranged such that the overall shape defined by plurality of holes 60 defines a predetermined shape 64.

The preferred embodiment of the predetermined shape 64 corresponding to the profile of the plurality of holes 60 of the plate assembly 56 is substantially the same to the cross section of the thermoplastic cornice member previously illustrated above in FIG. 1.

The material characteristics of the particular thermoplastic solid material would generally be known to those skilled in the art. As such, the apertures of each of the plurality of holes 60 and the spacing among the plurality of holes 62 are chosen based on the material characteristics such as the expansion characteristics of the material. In one embodiment of the present invention wherein the thermoplastic solid material 28 is a polystyrene foam, each of the plurality of holes 60 are between forty and fifty thousandths of an inch and the spacing 62 among the plurality of holes 60 is between fifty and sixty thousandths of an inch. More particularly, to ensure increased strength of the cornice member, each of the plurality of holes 60 may be between forty two and forty eight thousandths of an inch and preferably forty five thousandths of an inch. Also to ensure increased strength of the cornice member, the spacing 62 among the plurality of holes 60 is between fifty two and fifty eight thousandths of an inch and preferably fifty five thousandths of an inch.

The material continuously extruded through each of the plurality of holes 60 forms a strand 22. Each strand 22 is defined by a continuous extrusion of foam that comes into contact with adjacent strands 22 similarly formed. Each strand 22 will form a skin before coming into contact with an adjacent strand 22, as it exits the plate assembly 56. Since this skinning process occurs prior to the strand 22 becoming fused to adjacent strands 22, the strength of the foam increases and the moisture absorption of the foam is minimized. Generally speaking the skin will have a higher outer density than the inner density of the strand; adding to the strength of the product. In other words the plurality of substantially parallel strands coalesce into a mass having a cross section presenting a plurality of higher outer density skins to produce a rigid strong member.

Each of the plurality of holes 60 may generally be round but could be any shape to facilitate manufacturing of the final shape 64 of the cornice member.

Furthermore, the extruder 26 can be operated so as to produce a substantially continuous extruded material which generally exits the output 48 as a profile portion in the predetermined shape 64. The continuous extruded material may be produced in any desired length.

The temperature of the extruder 26 may be operated in a manner well known to those persons skilled in the art and in one example the hopper temperature may be operated at 105° C. while the heating zone 46 is operated at 160° C. and the output 48 operated at approximately 80° C. These temperatures, however, are given by way of example only and should not limit the invention described herein as other operating temperatures may be utilized depending on the thermoplastic material utilized.

As previously described, the plurality of holes 60 can be positioned such that the totality of extruded material is outputted from the output end 48 of the extruder 26 in a predetermined shape 64, such as the embodiment previously illustrated in FIG. 1. The extruded material in the predetermined shape 64 is then passed through a sizing or forming block 66 to smooth the surface of the extruded shape. The sizing or forming block 66 includes a passage 68 that forms the outline of the extruded shape.

In one embodiment a sizing or forming block 66 may preferably be placed approximately 3 inches from the output end 48 of the extruder 26. The sizing or forming block 66 is typically cooled and, since the sizing or forming block 66 particularly comes into contact only with the outer surface 2, 6 of the extrusion, therefore typically causes the outer surface of the cornice member to be of a higher density than the interior of the cornice member. Due to this density difference, the outer surface 2, 6 of the cornice member defines a substantially smooth and minimally porous surface that enables the cornice member to be less susceptible to intrusion of moisture and bacteria than prior art thermoplastic cornice members. Alternatively the cooling can occur due to heat transfer from the foamed product and strands to the ambient atmosphere.

The higher density outer surface 2, 6 also adds strength to the cornice member. Furthermore, higher density outer surface 2, 6 enables the surface to receive one or more layers of paint as desired for aesthetic reasons. The paint could be applied following the extrusion and cooling process or could be applied before or after installation. The painting process is further described below.

In the preferred embodiment of the invention wherein a polystyrene cornice member is formed, the density of the cornice member is between six and one pound per cubic foot, and more particularly provides an optimal strength between four and two pounds per cubic foot, and preferably about three pounds per cubic.

A member of thermoplastic cornice disclosed by the present invention may be affixed using an adhesive to a panel such as a wall, floor, or ceiling. Following the cooling process, the adhesive may be sprayed or brushed onto all of or a portion of one or both of the flat surfaces 10, 12 of the rear surface 6 of the cornice member so that one or both of the flat surfaces 10, 12 can be affixed to the panels. The adhesive 13 chosen is typically a pressure sensitive adhesive that enables the cornice to be held securely to the panel members, such as walls, without falling off due to the weight of the cornice member.

An easily removable adhesive backing 11 may be affixed to the adhesive to enable the adhesive to retain its stickiness and to prevent foreign objects such as dust from sticking to the adhesive during transport.

Therefore a user will peel back the backing (can be plastic, wax paper or the like) and quickly and efficiently apply the cornice so the adhesive will adhere to the wall and ceiling. This is much quicker and simpler than using plaster or wood cornice, which will generally require the use of a plasterer or carpenter. The foamed polystyrene cornice is also much lighter and easier to apply; that does not require an experience tradesperson.

Alternatively, the adhesive could be omitted and the cornice could be glued or nailed to one or both of the panels during installation.

The skinning process described above causes the outer surface 2, 6 of the cornice member to resemble a smooth white surface. Therefore, there is not always a need to paint the cornice member.

Also, as previously described, a dye can be used in the forming process to provide a cornice member in any color.

Alternatively, due to the skinning process causing a smooth outer surface 2, 6 of the cornice member, the cornice member can receive one or more layers of paint in order to meet the needs of a particular application. The paint can be applied after the cooling process or at the installation site by spraying or by brushing.

Although not necessarily visible to the naked eye, the strands on the outer surface 2, 6 of the cornice member cause the outer surface 2, 6 to have a plurality of ridges 70 causing a plurality of peaks and valleys on the outer surface 2, 6. The ridges 70 enable optimal adhesion to the cornice member of both the adhesive and the paint described above.

Alternatively, the ridges can be made more pronounced to enable further adhesion to the cornice member of the adhesive and the paint by shaping the sizing or forming block 66 with additional ridges edges rather than smooth edges. As the extrusion passes through the sizing or forming block 66 it will, therefore, be formed with said additional ridges in addition to its natural ridges 70.

FIG. 5 illustrates two adjoining adjacent cornice members. As previously described, the cornice member can be extruded continuously by the extrusion process described herein. For installation purposes, it may be necessary to cut the ends of some or all of the cornice members so that the cornice members can abut each other in an aesthetically pleasing manner. For example, where two adjacent walls 72, 74 meet at a ninety degree angle 76, two adjacent cornice members 78, 80 are cut at a forty five degree angle to optimally meet at a joint 82. Any other angle can also be cut according to particular needs. The cutting can be done during manufacture or installation.

Due to the characteristics of the extruded thermoplastic cornice member, the cornice member can be cut to the desired angle without flaking or braking.

Although the cornice member is extruded such that its surface forms a layer of higher density than the interior of the cornice member, it may be desirable in certain applications to co-extrude a surface layer for the cornice member. For example, this may be needed where the cornice member is used as a baseboard between a wall and a floor, where it is more susceptible to be bumped into.

A co-extruded outer layer is typically a denser material than the cornice member, to have more resilience to external forces. The co-extruded outer layer could also be a denser extrusion of the same material as the cornice member.

The co-extrusion can be formed using a parallel extrusion device as described above, with modifications to the mixture as necessary to produce the denser surface layer. The co-extrusion can be joined to the cornice member prior to cooling through passing through the sizing or forming block 66 so that the co-extrusion and the cornice member cool as one piece.

Alternatively, the co-extrusion can be adhered to the cornice member.

A further alternative is to adhere another material, such as a plastic layer, to the cooled cornice member.

Various embodiments of the invention have now been described in detail.

Since changes in and/or additions to the above-described best mode may be made without departing from the nature, spirit or scope of the invention, the invention is not to be limited to said details.

What is claimed is:

1. A method of producing a thermoplastic member, the method comprising:
(a) continuously extruding a thermoplastic material through an extrusion die, the extrusion die having a plurality of orifices, the plurality of orifices oriented on the extrusion die so as to define approximately the shape of the thermoplastic cornice member; and
(b) drawing the extrusion through a sizing and forming block to shape the thermoplastic cornice member into its final shape.

2. The method claimed in claim 1, wherein the thermoplastic material is polystyrene.

3. The method claimed in claim 1, wherein the thermoplastic material is formed by:
(a) introducing a plurality of solid thermoplastic pellets to an inlet of an axially extending barrel;
(b) conveying said solid thermoplastic pellets along said barrel using a means of conveyance comprising a screw conveyor axially disposed within said barrel;
(c) melting said solid thermoplastic pellets along a portion of said barrel having a temperature greater than the melting point of said thermoplastic. and
(d) further conveying said thermoplastic melt along said barrel using the means of conveyance to an output, said output comprising a plurality of holes arranged in a manner to permit an extruded substance to assume a predetermined shape, said shape being the cross section of a cornice member.

4. The method claimed in claim 1, the method further comprising permitting said extruded thermoplastic material to solidify.

5. The method claimed in claim 4, wherein the thermoplastic material is cooled to accelerate solidification.

6. The method claimed in claim 4, wherein the cooling of the thermoplastic material causes the outer surface of the thermoplastic material to have a higher density than the interior of the thermoplastic material.

7. The method claimed in claim 6, wherein the outer surface includes a plurality of ridges operable to receive one or more layers of paint or adhesive.

8. The method claimed in claim 1, wherein the thermoplastic material is separated into strands as it is passed through the plurality of orifices, the strands each forming a skin prior to coming into contact with adjacent strands.

9. The method claimed in claim 8, wherein the strands provide increased rigidity and strength to the thermoplastic cornice member.

10. The method claimed in claim 2, wherein the diameter of each orifice is between forty and fifty thousandths of an inch and the orifices are separated from adjacent orifices by between fifty and sixty thousandths of an inch.

11. The method claimed in claim 10, wherein the diameter of each orifice is between forty two and forty eight thousandths of an inch.

12. The method claimed in claim 11, wherein the diameter of each orifice is forty five thousandths of an inch.

13. The method claimed in claim 10, wherein the orifices are separated from adjacent orifices by between fifty two and fifty eight thousandths of an inch.

14. The method claimed in claim 13, wherein the orifices are separated from adjacent orifices by fifty five thousandths of an inch.

15. A thermoplastic member comprising:
(a) a thermoplastic material defined by a plurality of strands and a plurality of cells; and
(b) a surface layer of the thermoplastic material having a higher density than the interior of the thermoplastic material.

16. The cornice member claimed in claim 15, wherein the thermoplastic material is foamed polystyrene and said member comprises cornice.

17. The cornice member claimed in claim 16, wherein the density of the cornice member is between one and six pound per cubic foot.

18. The cornice member claimed in claim 17, wherein the density of the cornice member is between two and four pounds per cubic foot.

19. The cornice member claimed in claim 18, wherein the density of the cornice member is three pounds per cubic.
